(19) United States
(12) Patent Application Publication
(10) Pub. No.: US 2010/0131554 A1
(43) Pub. Date: May 27, 2010

(54) SYSTEM AND METHOD FOR PUBLISHING MESSAGES ASYNCHRONOUSLY IN A DISTRIBUTED DATABASE

(75) Inventor: Brian Cooper, San Jose, CA (US)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/324,767

(22) Filed: Nov. 26, 2008

(51) Int. Cl. G06F 17/30

(52) U.S. Cl. 707/770; 707/E17.032

(57) ABSTRACT

An improved system and method for publishing messages asynchronously in a distributed database is provided. Clusters of sequencer servers and broker servers may provide services for asynchronously publishing messages about topics including transactions for performing semantic operations on data in the distributed database system. A publisher client may send a message to a sequencer server that may add a sequence number to the message for the topic. The sequencer server may send the message to a primary broker server and a secondary broker server for asynchronous publication to subscribers of the topic of the message. If the primary broker server fails, the message sent to the secondary broker may be distributed to subscribers of the topic of the message. A subscriber client may receive the message and may order the messages received by sequence number for consumption by an application such as a subscriber database engine.

### FIELD OF THE INVENTION

The invention relates generally to computer systems, and more particularly to an improved system and method for publishing messages asynchronously in a distributed database.

### BACKGROUND OF THE INVENTION

In a distributed and replicated database, each data record may be replicated over several geographic regions, with one replica serving as the master data record that accepts updates and transmits them to the other replicas. Communication of updates between regions may be done through publishing messages to subscribers. The master region may publish record updates on an asynchronous channel to replicas that subscribe. Once an update is published, delivery should be guaranteed to all replicas. However, it is difficult to provide this guarantee in a large scale, replicated, distributed database.

Existing systems rely on a shared disk to survive failures. When one machine fails, another takes over for the failed machine, but the failover machine must access the shared disk to retrieve undelivered messages. This shared disk is often costly and is typically an expensive network attached storage device. Furthermore, adding capacity to a growing system requires buying more shared disk for reliability. Unfortunately, this makes scaling expensive.

What is needed is a mechanism to guarantee delivery of published messages to all subscribers in an asynchronous message publishing system. Such a system and method should recover from machine failures involved in publishing messages to subscribers and should easily scale for increased publication or subscription demand.

### SUMMARY OF THE INVENTION

The present invention provides a system and method for publishing messages asynchronously in a distributed database. In various embodiments, sequencer servers and broker servers may provide services for asynchronously publishing messages about topics that may include transactions for performing semantic operations on data in the distributed database system. Publisher clients may send messages to a cluster of sequencer servers that then sequence the messages by topic and distribute them randomly to a cluster of broker servers. The broker servers may deliver the messages to active subscriber clients and may persistently store the messages until they are delivered to active subscriber clients. A subscriber client may receive the messages and may order the messages received for consumption by an application such as a subscriber database engine. Advantageously, once a message may be published, the system and method reliably deliver the message to active subscribers.

A publisher client may determine which sequencer server in a cluster of sequencer servers is responsible for a message topic and sends a message to that sequencer server for publication to subscriber client registered for the topic. The sequencer server may assign a sequence number and a local sequence number for the topic to the message. The sequencing server may then randomly choose a primary broker server and a secondary broker server from the cluster of broker servers. The sequencer server may add the ID of the secondary broker server to a copy of the message, annotate the message as a primary message, and then send the message to the primary broker server. The sequencer server may add the ID of the primary broker server to a copy of the message, annotate the message as a secondary message, and then send the message to the secondary broker server. The sequencer server may receive acknowledgements from the primary and secondary broker servers and send an acknowledgement to the publisher client.

The primary broker server and the secondary broker server may receive the messages, may each persistently store the message in a log file, and may each send an acknowledgement to the sequencer server that the message is received for publication. Each broker server may then match the message with active subscriptions for the topic of the message. In addition to subscriber clients that may register for the topic, a sequencer server in another cluster or region may also register for a topic to receive messages from another region. Each broker server may store the destinations of subscribers with active subscription in their message log, and the primary broker server may send the message to subscriber clients with active subscriptions for the topic of the message. A subscriber client that receives the message may reorder the message in a queue of messages for the topic by sequence number, and consume the messages.

In order to reliably deliver the message to active subscribers, the present invention may recover from the failure of a sequencer server or a broker server. If the failure of a sequencer server is detected, another sequencer server may be chosen to handle the sequencing of topics of the failed sequencer server. The chosen sequencer server may send a request that lists topics to broker servers to obtain the sequence number and local sequence number of the last seen message for each topic listed. Using the sequence number and local sequence number received for each topic, the chosen sequencer server may build the topic sequence table for each topic and send a notification that the chosen sequence server is in service to accept publication messages for each topic. If the failure of a broker server is detected, a notification message may be sent to surviving broker servers that the broker server failed. Each surviving broker server may then check its message log for messages sent to the failed broker. A surviving broker server may copy and rewrite each primary message found as a secondary message. And a surviving broker server may copy and rewrite each secondary message found as a primary message. The surviving broker servers may then send the messages to randomly chosen surviving broker servers. A surviving broker server may then send a primary message to a subscriber client in response to a request to send a message for a missing sequence number.

Thus, the present invention may provide a mechanism to publish messages asynchronously in a distributed database and reliably deliver messages to active subscribers. By separating the sequencer servers and broker servers, the system and method may easily scale for increased publication demand and increased subscription demand. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for publishing messages asynchronously in a distributed database, in accordance with an aspect of the present invention;

FIG. 3 is a flowchart generally representing the steps undertaken in one embodiment on a client for publishing messages asynchronously in a distributed database, in accordance with an aspect of the present invention;

FIG. 4 is a flowchart generally representing the steps undertaken in one embodiment for publishing messages asynchronously in a distributed database to a remote region, in accordance with an aspect of the present invention;

FIG. 5 is a flowchart generally representing the steps undertaken in one embodiment on a sequencer server for publishing messages asynchronously in a distributed database, in accordance with an aspect of the present invention;

FIG. 6 is a flowchart generally representing the steps undertaken in one embodiment for recovering from failure of a sequencer server for publishing messages asynchronously in a distributed database, in accordance with an aspect of the present invention;

FIG. 7 is a flowchart generally representing the steps undertaken in one embodiment on a broker server for publishing messages asynchronously in a distributed database, in accordance with an aspect of the present invention; and

FIG. 8 is a flowchart generally representing the steps undertaken in one embodiment for recovering from failure of a broker server for publishing messages asynchronously in a distributed database, in accordance with an aspect of the present invention.

### DETAILED DESCRIPTION

### Exemplary Operating Environment

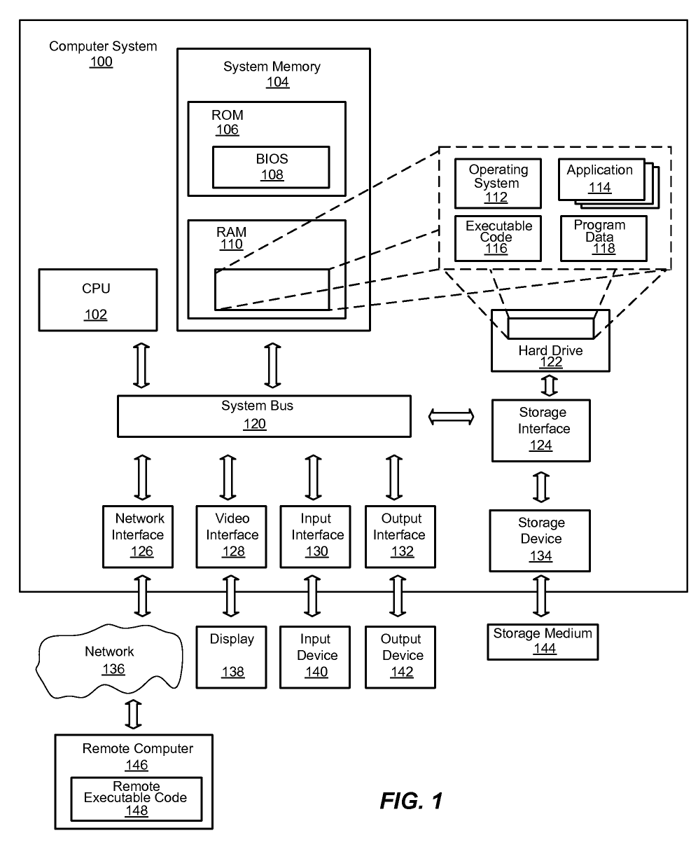

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Publishing Messages Asynchronously in a Distributed Database

The present invention is generally directed towards a system and method for publishing messages asynchronously in a distributed database. In an embodiment, sequencer servers and broker servers may provide services for asynchronously publishing messages about topics that may include transactions for performing semantic operations on data in the distributed database system. Publisher clients may send messages to a cluster of sequencer servers. The cluster of sequencer servers is responsible for accepting publishes of messages and assigning order to messages within a particular topic. Sequencer servers may then scatter copies of the messages among a cluster of broker servers. The broker servers are responsible delivering the messages to active subscriber clients and for persistently storing messages until they are delivered to active subscriber clients. A subscriber client may receive messages and may order the messages received for consumption by an application such as a subscriber database engine. Advantageously, once a message may be published, the system and method reliably deliver the message to active subscribers.

As will be seen, separating the sequencer servers and broker servers allows scalability both for publish throughput and delivery throughput. If there is a high rate of publishes, more sequencer servers may be added to keep up with the increased load. If the number of subscriber clients increases on topics, more broker servers may be added to keep up with the delivery load. Separating the sequencer servers and broker servers may also provide greater reliability since individual servers do not share memory or disk, but instead share information using network communication. As will be understood, the various block diagrams, flow charts and scenarios described herein are only examples, and there are many other scenarios to which the present invention will apply.

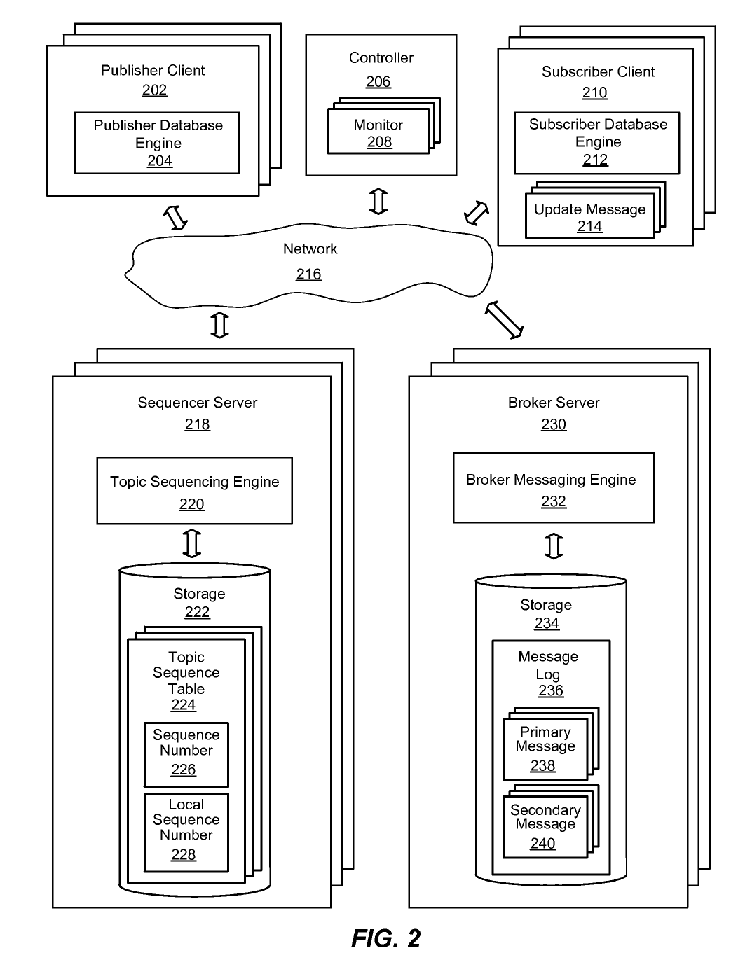

Turning to FIG. 2 of the drawings, there is shown a block diagram generally representing an exemplary architecture of system components for publishing messages asynchronously in a distributed database. Those skilled in the art will appreciate that the functionality implemented within the blocks illustrated in the diagram may be implemented as separate components or the functionality of several or all of the blocks may be implemented within a single component. For example, the functionality for the broker messaging engine 232 on the broker server 230 may be implemented as two separate components, for instance, a broker messaging engine and a subscription matching engine. Or the functionality for the broker messaging engine 232 may be implemented in the same component as shown. Moreover, those skilled in the art will appreciate that the functionality implemented within the blocks illustrated in the diagram may be executed on a single computer or distributed across a plurality of computers for execution.

In various embodiments, several networked client computers, such as publisher client 202 and subscriber client 210, may be operably coupled to several sequencer servers 218 and to several broker servers 230 by a network 216. Each publisher client 202 and each subscriber client 210 may be a computer such as computer system 100 of FIG. 1. The network 216 may be any type of network such as a local area network (LAN), a wide area network (WAN), or other type of network. A publisher database engine 204 may execute on the publisher client 202 and may include functionality for sending a message to a sequencer server 218 to publish a message for a topic to subscribers such as subscriber client 210 or other sequencer servers 218 in another region. The message may be a database update message for a particular set of database tables classified under a particular topic. A subscriber database engine 212 may execute on the subscriber client 210 and may include functionality for receiving messages such as update messages 214. A subscriber client 210 may register to receive messages for one or more topics. In general, the publisher database engine 204 and the subscriber database engine 212 may be any type of interpreted or executable software code such as a kernel component, an application program, a script, a linked library, an object with methods, and so forth.

The sequencer servers 218, the broker servers 230 and the controller 206 may be any type of computer system or computing device such as computer system 100 of FIG. 1. The sequencer servers 218 and the broker servers 230 may be part of a large distributed database system of operably coupled servers. Together, sequencer servers 218 and broker servers 230 may provide services for asynchronously publishing messages about topics that may include transactions for performing semantic operations on data in the distributed database system. A controller 206 may be operably coupled by the network 216 to the sequencer servers 218 and the broker servers 230. The controller 206 may include a monitor 208 that provides services for detecting failover and recovery of the sequencer servers 218 and the broker servers 230.

A sequencer server 218 may provide services for sequencing messages about one or more topics and sending the messages to broker servers for distribution. A sequencer server 218 may include a topic sequencing engine 220 which may add sequence numbers to messages for a particular topic. The topic sequencing engine 220 may be operably coupled to storage 222 that stores one or more topic sequence tables 224 with the current sequence number 226 and the current local sequence number 228. The storage 208 may be any type of computer storage media. In an embodiment, a sequencer server 218 may send a copy of a message with a sequence number to a primary broker server which may be referred to as a primary message. And the sequencer server 218 may send a copy of the message with a sequence number to a secondary broker which may be referred to as a secondary message.

A broker server 230 may provide services for distributing messages about the topics to subscribers registered for the topics. A broker server 230 may include a broker messaging engine 232 which may identify subscribers registered for the topic of messages received and which may send the messages to those subscribers registered for the topic. The broker messaging engine 232 may be operably coupled to storage 234 that stores one or more message logs 236 with primary messages 238 and secondary messages received by the broker server 230. The storage 234 may be any type of computer storage media.

In general, the monitor 208, the topic sequencing engine 220 and the broker messaging engine 232 may be any type of executable software code that may execute on a computer such as computer system 100 of FIG. 1, including a kernel component, an application program, a linked library, an object with methods, or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

In an embodiment for publishing messages asynchronously in a distributed database, the distributed database system may be configured into clusters of servers with the data tables and indexes replicated in each cluster. In a clustered configuration, the database is partitioned across multiple servers so that different records are stored on different servers. Moreover, the database may be replicated so that an entire data table is copied to multiple clusters. This replication enhances both performance by having a nearby copy of the table to reduce latency for database clients and reliability by having multiple copies to provide fault tolerance.

To ensure consistency, the distributed database system may also feature a data mastering scheme. In an embodiment, one copy of the data may be designated as the master, and all updates are applied at the master before being replicated to other copies. In various embodiments, the granularity of mastership could be for a table, a partition of a table, or a record. For example, mastership of a partition of a table may be used when data is inserted or deleted, and once a record exists, record-level mastership may be used to synchronize updates to the record. The mastership scheme sequences all insert, update, and delete events on a record into a single, consistent history for the record. This history may be consistent for each replica.

Communication of updates between clusters or regions may be done through publishing messages to subscribers. The master region may publish record updates on an asynchronous channel to replicas that subscribe. Once an update is published to the sequencer servers, it will be delivered to all replicas. Thus, publication of messages is persistent. Once a message is written to a broker server, that message is saved to survive machine failure and is guaranteed to be delivered to all regions. A message may be finally deleted once all subscribers have received it, acted on it, and explicitly allowed it to be deleted.

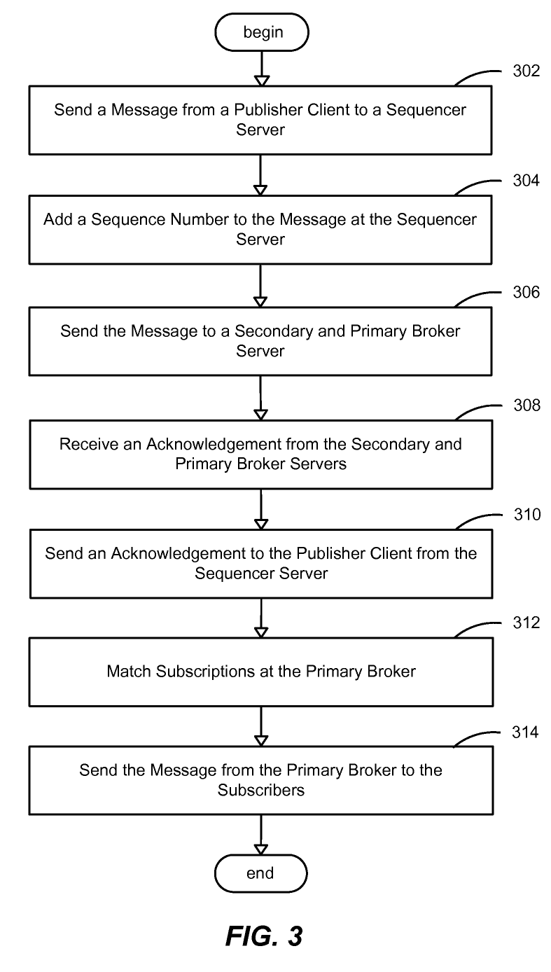

FIG. 3 presents a flowchart for generally representing the steps undertaken in one embodiment for publishing messages asynchronously in a distributed database. At step 302, a message may be sent from a publisher client to a sequencer server for a transaction to be published asynchronously in a distributed database. For example, a publisher database engine may send a message to update a data record in a distributed database. At step 304, the sequencer server may add a sequence number to the message. A sequence number may be any positive integer, and each sequence number assigned must be incremented by a value of 1 so that a sequence of positive integers is generated that is strictly increasing by an increment of 1. In general, the sequence number can be any globally unique value. For example, the IP address of the sequence server may be concatenated with an increasing sequence number.

At step 306, the sequencer server may send the message with the sequence number to a primary broker server and a secondary broker server for asynchronous publication in a distributed database. For instance, the message may be copied, the ID of the secondary broker server may be added to the message, and the message may be sent to a primary broker server to be distributed to subscribers of the topic of the message. The message may also be copied, the ID of the primary broker may be added to the message, and the message may be sent to the secondary broker to be distributed to subscribers of the topic of the message if the primary broker server fails to deliver the message.

The sequencer server may then receive an acknowledgement at step 308 from the primary broker server and from the secondary broker server. Upon receiving the acknowledgements from the primary broker server and the secondary broker server, the sequencer server may send an acknowledgement to the publisher client at step 310. In an embodiment, a publisher client may republish the message if an acknowledgement has not been received before the expiration of a timer for a predetermined time period. The primary broker server may then match subscriptions for the topic of the message received at step 312 and may send the message to those subscribers registered for the topic at step 314. A subscriber client may receive the message and may order the messages received by sequence number for consumption by an application that depends upon the order of the messages such as a subscriber database engine. In an embodiment, the subscriber client may place messages received in a priority queue sorting on the sequence number, reorder the message in order by sequence number, and consume the messages.

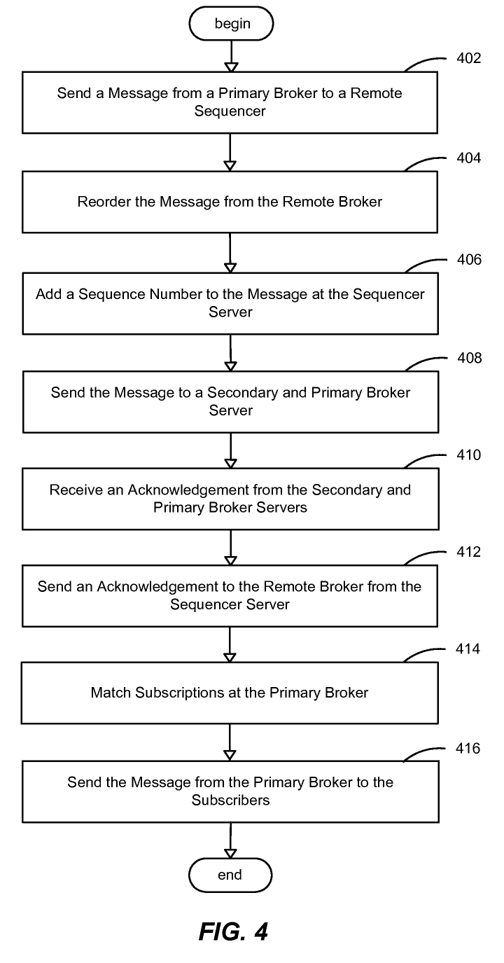

FIG. 4 presents a flowchart for generally representing the steps undertaken in one embodiment for publishing messages asynchronously in a distributed database to a remote region. When a broker server may receive a message sent from a sequencer server, the broker server may match subscriptions for the topic of the message received and may send the message to those subscribers registered for the topic. In addition to subscriber clients that may register for the topic, a sequencer server in another cluster or region may also register for a topic to receive messages from another region. In an embodiment, a cluster in a region may send a “peer subscribe” message to each remote region cluster. Thus a cluster may register as a regular subscriber except that a cluster may only forward messages published locally to remote regions. Thus a broker server may identify a remote sequencer server as a subscriber of a topic and may send the message to a remote region.

At step 402, a message may be sent from a primary broker to a remote sequence server. At step 404, a sequence server in the remote region may reorder the message. At step 406, the sequencer server may add a sequence number to the message. At step 408, the sequencer server may send the message with the sequence number to a primary broker server and a secondary broker server for asynchronous publication in a distributed database. For instance, the message may be copied, the ID of the secondary broker server may be added to the message, and the message may be sent to a primary broker server to be distributed to subscribers of the topic of the message. The message may also be copied, the ID of the primary broker may be added to the message, and the message may be sent to the secondary broker to be distributed to subscribers of the topic of the message if the primary broker server fails to deliver the message.

The sequencer server may then receive an acknowledgement at step 410 from the primary broker server and from the secondary broker server. Upon receiving the acknowledgements from the primary broker server and the secondary broker server, the sequencer server may send an acknowledgement to the remote broker server at step 412. In an embodiment, the remote broker server may resend the message to the sequence server if an acknowledgement has not been received before the expiration of a timer for a predetermined time period. The primary broker server may then match subscriptions for the topic of the message received at step 414 and may send the message to those subscribers registered for the topic at step 416.

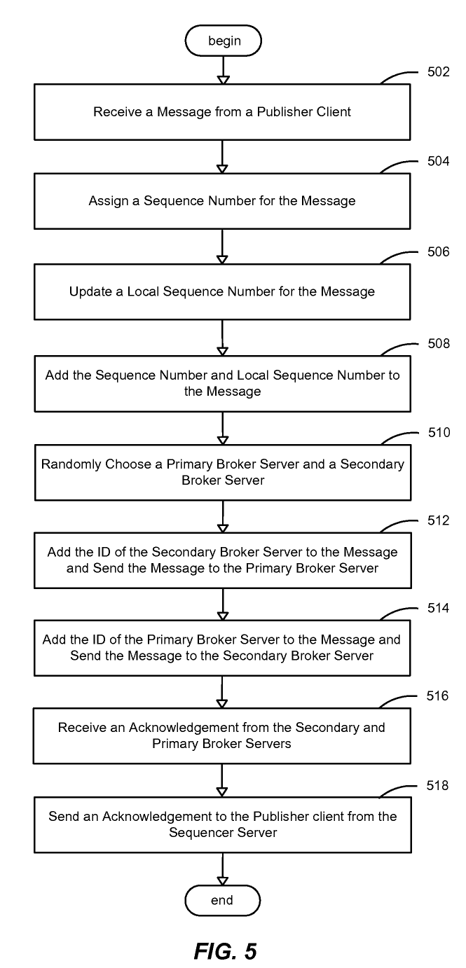

FIG. 5 presents a flowchart for generally representing the steps undertaken in one embodiment on a sequencer server for publishing messages asynchronously in a distributed database. At step 502, a sequencer server may receive a message for a transaction to be published asynchronously in a distributed database. For example, the sequencer server may receive the message from a publisher database engine operating on a publisher client requesting to update a data record in a distributed database. The publisher client may determine which sequencer is responsible for the message topic, for instance, by querying a controller and sends the message to that sequencer. At step 504, the sequencer server may assign a sequence number for the message. In an embodiment, a topic sequencer engine operating on the sequencer server may retrieve the current sequence number from the topic sequence table for the topic of the message, increment the sequence number, assign the sequence number to the message, and store the incremented sequence number in the topic sequence table. At step 506, the sequencer server may update a local sequence number for the message. The local sequence number is the current sequence number for the subset of topic messages that were published directly to a particular cluster and may be used to determine how to sequence messages that are forwarded to remote regions. In an embodiment, a topic sequencer engine operating on the sequencer server may retrieve the current local sequence number from the topic sequence table for the topic of the message, increment the local sequence number, assign the local sequence number to the message, and store the incremented sequence number in the topic sequence table. At step 508, the sequencer server may add the incremented sequence number and local sequence number to the message.

The sequencing server may then randomly choose a primary broker server and a secondary broker server at step 510. At step 512, the sequencer server may add the ID of the secondary broker server to the message and then send the message to the primary broker server. In an embodiment, the sequencer server may also annotate the message as the primary message. At step 514, the sequencer server may add the ID of the primary broker server to the message and then send the message to the secondary broker server. In an embodiment, the sequencer server may also annotate the message as the secondary message. At step 516, an acknowledgment may be received from the primary and secondary broker servers. At step 518, the sequencer server may send an acknowledgement to the publisher client and processing may be finished on a sequencer server for publishing messages asynchronously in a distributed database.

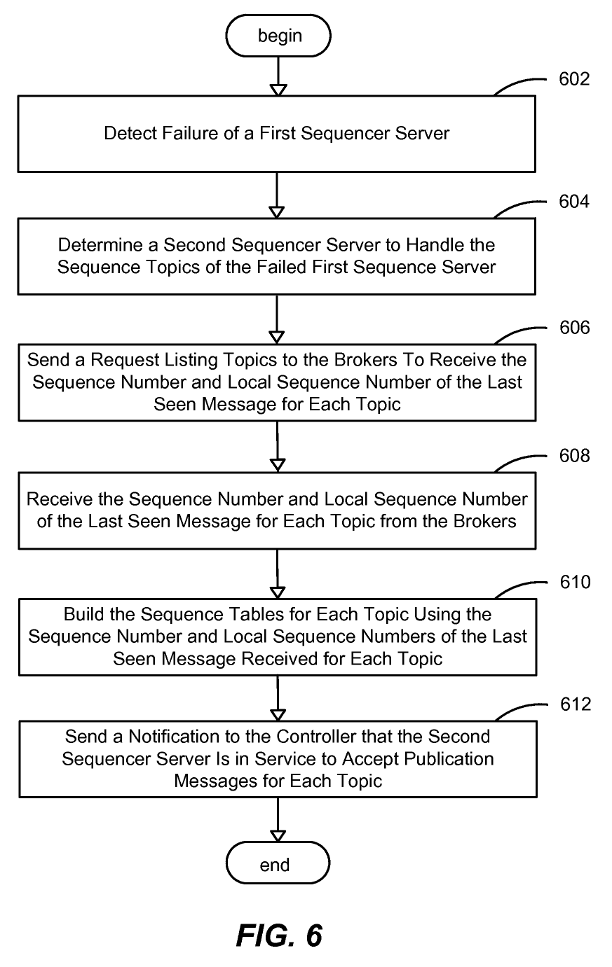

FIG. 6 presents a flowchart for generally representing the steps undertaken in one embodiment for recovering from failure of a sequencer server for publishing messages asynchronously in a distributed database. At step 602, failure of a sequencer server may be detected. In an embodiment, the failure of a sequencer server may be detected by a monitor executing on a controller that receives a periodic message from each active sequence server in a region. Alternatively, a publisher client may detect the failure of a sequence server if the publisher client experiences repeated failure to receive acknowledgements for published messages. At step 604, a second sequencer server may be determined to handle the sequencing of topics of the failed sequencer server. In an embodiment, the controller may choose a new server or an existing server which may be based upon the load of each active sequencer server. The second sequencer server may then send a request at step 606 that lists topics to broker servers to obtain the sequence number and local sequence number of the last seen message for each topic listed, and the second sequence server may receive at step 608 the sequence number and local sequence number of the last seen message for each topic listed.

At step 610, the second sequencer server may build the topic sequence table for each topic using the sequence number and local sequence number of the last seen message received for each topic. And the second sequence server may send notification to the controller that the second sequence server is in service to accept publication messages for each topic at step 612. Those skilled in the art will appreciate in another embodiment for detection and recovery of failure of a sequence server, the topics on the failed sequence server may be spread among the existing sequencer servers, each of which may perform the steps 606-612 of the recovery process described above. Then, the load of the failed sequencer may be evenly spread among active sequencer servers.

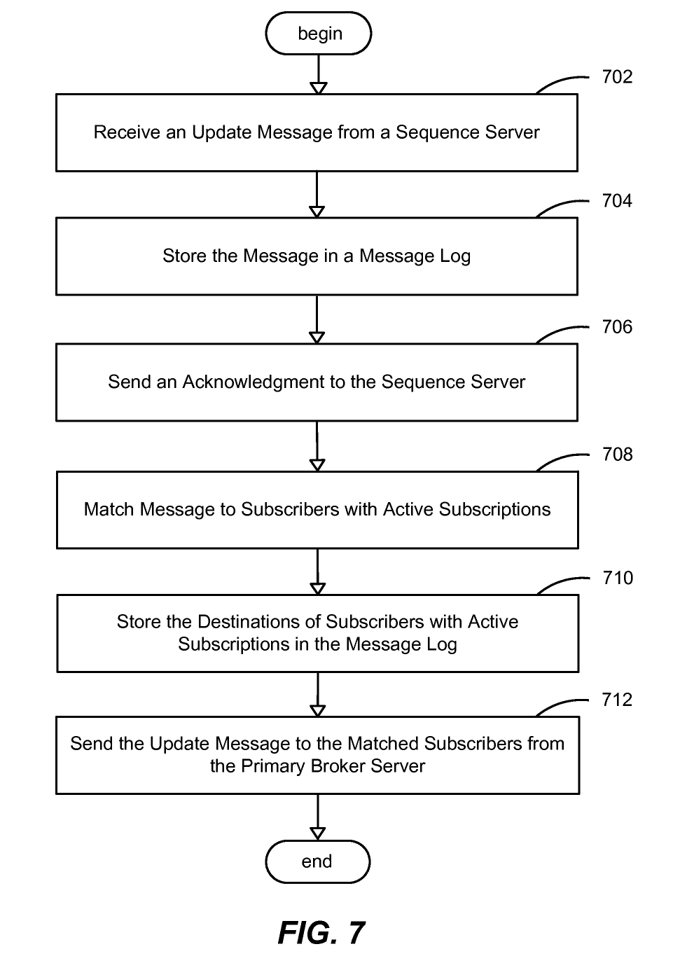

FIG. 7 presents a flowchart for generally representing the steps undertaken in one embodiment on a broker server for publishing messages asynchronously in a distributed database. At step 702, a broker server may receive a message to be published asynchronously to subscribers in a distributed database. For example, the broker server may receive the message from a sequencer server that has added a sequence number and a local sequence number to the message. In an embodiment, the message may be annotated as a primary message and may include the ID of a secondary broker server. Or the message may be annotated as a secondary message and may include the ID of a primary broker server. At step 704, the broker server may persistently store the message in a log file on the broker server. At step 706, the broker server may send an acknowledgement to the sequencer server that the message is received for publication.

At step 708, the broker server may then match the message with active subscriptions for the topic of the message. In addition to subscriber clients that may register for the topic, a sequencer server in another cluster or region may also register for a topic to receive messages from another region. In this case, the broker server may identify that the subscription is a “peer-subscribe” from a remote region. The broker server may then check whether the “locally-published” flag may be set indicating that the message was locally published. The broker server may then forward the message if the locally published flag is set. In an embodiment, the broker server may rewrite the message annotations by replacing the sequence number with the local sequence number and clearing the locally published flag. The sequence number, which was formerly the local sequence number, may then be used to resequence messages delivered to the remote sequencer from local brokers. The sequencer in the remote cluster may receive the message and sequence it, but the remote sequencer does not mark it as “locally published” or increment the local sequence number.

At step 710, the broker server may store the destinations of subscribers with active subscription in the message log. And at step 712, the broker server may send the message to those subscribers registered for the topic if the message is annotated to be a primary message, and processing may be finished on a broker server for publishing messages asynchronously in a distributed database.

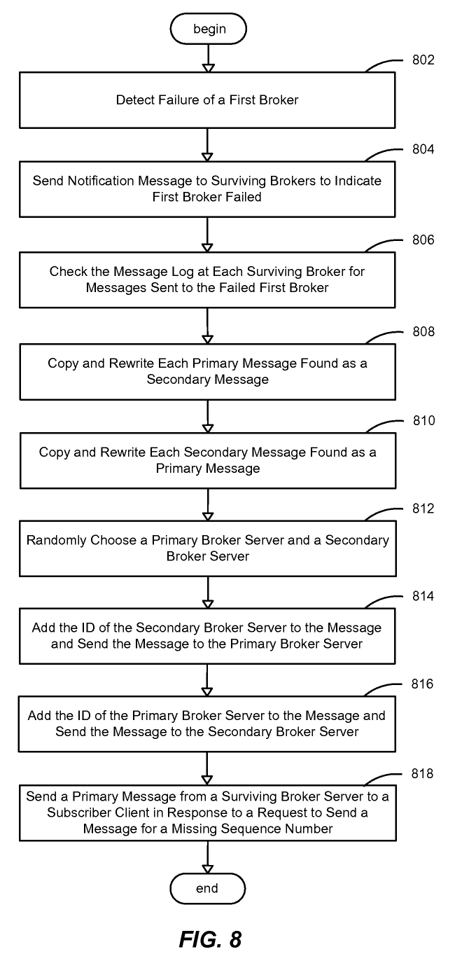

FIG. 8 presents a flowchart for generally representing the steps undertaken in one embodiment for recovering from failure of a broker server for publishing messages asynchronously in a distributed database. At step 802, failure of a broker server may be detected. In an embodiment, the failure of a broker server may be detected by a monitor executing on a controller that receives a periodic message from each active broker server in a region. Alternatively, a sequencer server may detect the failure of a broker server if the sequencer server experiences repeated failure to receive an acknowledgement for messages sent to the broker server. At step 804, a notification message may be sent to surviving broker servers that indicates a broker failed. Each surviving broker server may then check its message log at step 806 for messages sent to the failed broker. A surviving broker server may copy and rewrite each primary message found as a secondary message at step 808. And a surviving broker server may copy and rewrite each secondary message found as a primary message at step 810.

A broker server may then randomly choose a primary broker server and a secondary broker server at step 812. At step 814, the broker server may add the ID of the secondary broker server to the message and then send the message to the primary broker server. At step 816, the broker server may add the ID of the primary broker server to the message and then send the message to the secondary broker server. At step 818, a broker server may send a primary message from a surviving broker to a subscriber client in response to a request to send a message for a missing sequence number. In an embodiment, a subscriber client may timeout waiting or a missing message, and broadcast a request to broker servers to redeliver the message. Those skilled in the art will appreciate that an implementation may not rebuild redundancy for a failed broker server. In such an implementation, surviving broker servers may simply respond to a request from a subscriber client for a missing message by checking its message log for the missing messages sent to the failed broker and sending it to the subscriber client if found.

The system and method of the present invention may thus provide topic-oriented message publishing for subscribers using message scattering across a cluster of brokers that do not share memory or disk. The scattering avoids dependence on the availability of any server, and makes the system more resilient to failures while enhancing load balancing. By storing N copies of every message, the system reliably delivers messages even in the presence of N-1 failures. The scattering of message replicas to brokers ensures that the load of persisting messages is evenly spread across available broker machines, regardless of the varying load on different topics. This load balancing continues even after the failure of a broker machine, as the extra load induced by the loss of capacity is evenly redistributed across the surviving brokers.

Importantly, no component is a single point of failure. Sequencer servers may keep only soft state, primarily topic sequence counters, so if a sequencer server fails, it can be replaced with another sequencer server that can easily reconstruct the soft state from the broker servers. If a broker server fails, other broker servers may continue to deliver messages. And even if a failed broker server loses stored messages, those messages are redundantly stored elsewhere. Thus once a message may be published, the system and method reliably deliver the message to active subscribers. Moreover, the messages may be delivered to an application in the order they are published, even despite failures.

As can be seen from the foregoing detailed description, the present invention provides an improved system and method for publishing messages asynchronously in a distributed database. Together, sequencer servers and broker servers may provide services for asynchronously publishing messages about topics that may include transactions for performing semantic operations on data in the distributed database system. A publisher client may send a message to a sequencer server, and the sequencer server may add a sequence number to the message. The sequencer server may send the message with the sequence number to a primary broker server and a secondary broker server for asynchronous publication to subscribers of the topic of the message in a distributed database. If the primary broker server fails to deliver the message, the message sent to the secondary broker may be distributed to subscribers of the topic of the message. A subscriber client may receive the message and may order the messages received by sequence number for consumption by an application that depends upon the order of the messages such as a subscriber database engine. Advantageously, once a message may be published, the system and method reliably deliver the message to active subscribers. As a result, the system and method provide significant advantages and benefits needed in contemporary computing, and more particularly in distributed database applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for publishing messages, comprising:
a plurality of sequencer servers that sequence and distribute a plurality of messages by a plurality of topics that include transactions for performing semantic operations on data in a distributed database system;
a plurality of broker servers operably coupled to the plurality of sequencer servers that receive the plurality of messages sequenced by the plurality of topics and send the plurality of messages to a plurality of subscriber clients registered for at least one of the plurality of topics; and
a network operably coupled to the plurality of sequencer servers and operably coupled to the plurality of broker servers for communicating the plurality of messages sequenced by the plurality of topics from the plurality of sequencer servers to the plurality of broker servers.

2. The system of claim 1 further comprising a plurality of subscriber clients operably coupled to the network that register for the at least one of the plurality of topics and receive a plurality of messages sequenced for the at least one of the plurality of topics.

3. The system of claim 1 further comprising a plurality of publisher clients operably coupled to the network that publish to the plurality of sequencer servers the plurality of messages by the plurality of topics that include transactions for performing semantic operations on data in the distributed database system.

4. The system of claim 1 further comprising a controller operably coupled the network that detects failure of at least one of the plurality of sequencer servers and the plurality of broker servers.

5. A computer-implemented method for publishing messages, comprising:
receiving a message for a transaction to be published asynchronously in a distributed database to a plurality of subscriber servers registered for a topic of the message;
adding a sequence number for the topic to the message;
randomly distributing the message to a plurality of broker servers; and
sending an acknowledgement to a publisher client.

6. The method of claim 5 further comprising storing the message in a message log at a plurality of broker servers.

7. The method of claim 5 further comprising identifying the plurality of subscriber servers registered for the topic of the message.

8. The method of claim 5 further comprising storing the destinations of the plurality of subscriber servers registered for the topic of the message in a message log at a plurality of broker servers.

9. The method of claim 5 further comprising sending an acknowledgement from a plurality of broker servers.

10. The method of claim 5 further comprising receiving an acknowledgement from a plurality of broker servers.

11. The method of claim 5 further comprising sending the message from at least one of the plurality of broker servers to the plurality of subscriber servers registered for the topic of the message.

12. The method of claim 5 further comprising receiving the message from at least one of the plurality of broker servers by at least one of the plurality of subscriber servers registered for the topic of the message and ordering the message by the sequence number for the topic within a plurality of messages received by the at least one of the plurality of subscriber servers.

13. The method of claim 5 further comprising sending the message from at least one of the plurality of broker servers to a sequencer server in a remote region.

14. The method of claim 13 further comprising reordering the message at the sequencer server in the remote region.

15. The method of claim 5 further comprising:
detecting a failed sequencer server;
determining a second sequencer server to handle sequencing of a topic of the failed sequencer server; and
building a topic sequence table including a last seen sequence number for the topic; and
storing the topic sequence table including the last seen sequence number for the topic.

16. The method of claim 5 further comprising:
detecting a failed broker server;
sending notification of the failed broker server to a plurality of surviving broker servers;
checking a message log by each of a plurality of surviving broker servers to find one or more messages sent to the failed broker server; and
sending the one or more messages to at least one subscriber client in response to a request to send the one or more messages for a missing sequence number.
obtaining a number of partitions from the data partitioning policy for partitioning the application data into the plurality of data partitions.

17. The method of claim 16 further comprising rewriting the one or more messages sent to the failed broker server and sending the one or more messages to a plurality of randomly chosen surviving broker servers.

18. A computer-readable medium having computer-executable instructions for performing the method of claim 5.

19. A computer system for publishing messages, comprising:
means for receiving a message for a transaction to be published asynchronously in a distributed database to a plurality of subscriber servers registered for a topic of the message;
means for ordering the message published asynchronously in the distributed database to the plurality of subscriber servers registered for the topic of the message;
means for distributing the message to a plurality of broker servers; and
means for the plurality of broker servers to deliver the message to the plurality of subscriber servers registered for the topic of the message.

20. The computer system of claim 19 further comprising:
means for sending the message for the transaction to be published asynchronously in the distributed database to the plurality of subscriber servers registered for the topic of the message; and
means for the plurality of subscriber servers to order the message within a sequence of messages received for the topic.
